(19) United States
(12) Patent Application Publication
(10) Pub. No.: US 2022/0065601 A1
(43) Pub. Date: Mar. 3, 2022

(54) UNMANNED SURFACE VESSEL

(71) Applicant: Solar Sailor Pty Ltd, Middle Cove (AU)

(72) Inventor: Robert Dane, Middle Cove (AU)

(21) Appl. No.: 17/427,045

(22) PCT Filed: Dec. 6, 2019
(86) PCT No.: PCT/AU2019/051342

§ 371 Date: Jul. 29, 2021

(30) Foreign Application Priority Data
Jan. 31, 2019 (AU) 2019900284

(51) Int. Cl. F42B 19/38; B63B 1/24; B63G 5/00; B63B 1/26; B63B 1/28; B63B 1/30; F42B 19/12

(52) U.S. Cl. CPC F42B 19/38; B63B 1/246; B63G 5/00; B63B 2035/007; B63B 1/285; B63B 1/30; F42B 19/125; B63B 1/26

(57) ABSTRACT

The present invention is broadly directed to an unmanned surface vessel (USV) 10 broadly comprising: 1. a vessel body (12) adapted to contain a payload (14); 2. a front fin (16) and a rear fin (18) connected to and protruding from the vessel body (12); 3. a forward foil (20) and a rearward foil (22) connected to a distal end region of the respective front and rear fins (16) and (18); 4. propulsion means (24) operatively coupled to the rear fin (18) for propulsion of the fin (18) and the foil (22) through the water.

### TECHNICAL FIELD

The present invention relates broadly to a foiling unmanned surface vessel (USV) as well as a foiling USV assembly. The invention is directed more particularly to a foiling USV in the form of a foiling missile or a foiling USV intended for sprint and drift tactics or other defence operations.

### BACKGROUND

Unmanned surface vessels USVs) in the current state of the art are either displacement or planing vessels. The water drag or resistance associated with these conventional USVs means they have limited speed and range. Consequently these relatively low speed and high drag USVs have limited marine application and in particular limited deployment for Defence operations.

### SUMMARY OF INVENTION

According to a first aspect of the present invention there is provided a foiling unmanned surface vessel comprising:

a vessel body adapted to contain a payload;

a fin at a proximal end connected to and protruding from the vessel body;

a foil connected to a distal end region of the fin, the foil being oriented generally transverse to and extending from the fin;

propulsion means operatively coupled to the fin for propulsion of the fin and the foil through the water whereby the foil is effective in lifting the vessel body via the fin substantially clear of the water for foiling of the foiling unmanned surface vessel at relatively high speeds with the propulsion means remaining submerged in the water.

Preferably the fin is one of a pair of fins located at a front and a rear of the vessel body, respectively. More preferably the foil is one of a pair of foils in the form of a forward and a rearward foil connected to the forward and the rearward fins, respectively. Still more preferably the rearward fin is pivotally mounted to the vessel body for pivoting to effect steerage of the foiling unmanned surface vessel. Even more preferably the forward fin and the associated foil are located at or near the centre of the gravity of the foiling unmanned surface vessel.

Preferably the propulsion means includes an electric motor mounted to the fin, and a propeller coupled to the electric motor for propulsion of the foiling unmanned surface vessel. More preferably the propulsion means includes a battery housed within the vessel body and electrically coupled to the electric motor for powering it. Still more preferably the electric motor is in the form of an electric pod motor.

Preferably the foiling unmanned surface vessel also comprises flight control means operatively coupled to the vessel body to control its flight above the water. More preferably the flight control means includes a surface water actuator operatively coupled to the fin for tilting of the fin thereby changing the angle of the foil relative to the water which influences the flight path of the vessel body. Still more preferably the surface water actuator includes a wand at a proximal end being pivotally mounted to the front of the vessel body, a distal end of the wand configured to skim the surface of the water and, depending on the height of the vessel body above the water, pivot for tilting of the fin thereby adjusting the flight path of the vessel body to maintain foiling of the foiling unmanned surface vessel. Alternatively the foil or part thereof is moveable via the surface water actuator to influence the flight path of the vessel body. Even more preferably the surface water actuator is operatively coupled to the forward fin or in the alternative arrangement the forward foil.

Preferably the vessel body includes a ballast tank configured for flooding with water to effect sinking of the foiling unmanned surface vessel. More preferably the ballast tank is arranged for flooding when the vessel body is substantially stationary and at least partly submerged in the water.

According to a second aspect of the invention there is provided a foiling unmanned surface vessel assembly comprising:
a) a foiling unmanned surface vessel including:
   a vessel body adapted to contain a payload;
   a fin at a proximal end connected to and protruding from the vessel body;
   a foil connected to a distal end region of the fin, the foil being oriented generally transverse to and extending from the fin;
   propulsion means operatively coupled to the fin for propulsion of the foil through the water,
b) a launch sub-assembly arranged to cooperate with the foiling unmanned surface vessel for launching of said unmanned vessel into the water whereby the foil is effective in lifting the vessel body via the fin substantially clear of the water for foiling of the foiling unmanned surface vessel at relatively high speed with the propulsion means remaining submerged in the water.

Preferably the launch sub-assembly includes a launch tube configured to at least in part contain the vessel body in preparation for its launch from the launch sub-assembly. More preferably the launch tube is internally shaped at least in part substantially complementary to the vessel body.

Preferably the foiling unmanned surface vessel is configured to operate in either i) a launch mode where the vessel body is contained in the launch tube with the fin and the associated foil retracted, or ii) a deployed mode where the vessel body is launched from the launch tube with the fin protruding from the vessel body and the associated foil in its operative position to promote foiling of the foiling unmanned surface vessel. More preferably the vessel body includes a fin and foil recess within which the fin and the foil nest with the vessel body contained in the launch tube in the launch mode. Still more preferably the foil is at least in part constructed of a resiliently flexible material which with the foiling unmanned surface vessel in the launch mode deforms to permit nesting of the foil within the fin and foil recess. Alternatively the foil is pivotally connected to the fin whereby in the launch mode pivoting of the foil about the fin permits nesting of the foil within the fin and foil recess.

Preferably the fin is pivotally mounted to the vessel body for pivotal movement between its retracted and protruding positions. More preferably the foiling unmanned surface vessel also comprises biasing means coupled to the fin to urge it toward the protruding position whereupon the associated foil promotes foiling of the foiling unmanned surface vessel.

Preferably the foiling unmanned surface vessel also comprises a target sensor associated with the vessel body for homing of the foiling unmanned surface vessel to a target or other location. More preferably the vessel body includes a sensor compartment within which the target sensor is housed. Even more preferably the target sensor includes but is not limited to radar, visual sensors, infrared, or lidar. Still more preferably the target sensor is configured to communicate with target recognition and collision avoidance software.

Preferably the foiling unmanned surface vessel further comprises navigation electronics associated with the vessel body to control tracking of said foiling vessel to a target or other location. More preferably the navigation electronics includes a GPS antenna connected to the vessel body. Even more preferably the GPS antenna is movably coupled to the vessel body whereby the antenna retracts relative to the vessel body in the launch mode, and extends from the vessel body in the deployed mode.

Preferably the payload includes explosives or warheads wherein the foiling unmanned surface vessel acts as a self-sacrificing weapon. More preferably the foiling unmanned surface vessel includes a detonator or activator designed to activate the explosives or warheads.

Alternatively the payload includes payload sensors wherein the foiling unmanned surface vessel is intended for sprint and drift tactics or other defence operations. In this variation the payload sensors include but are not limited to camera, hydrophone, sonar, devices for sensing electronic signatures, electronic warfare electronics including radio, infrared detectors, radar, or lidar.

Foiling unmanned surface vessel in the context of this invention is to be understood as including a foiling missile, torpedo or other unmanned delivery device.

### BRIEF DESCRIPTION OF DRAWINGS

In order to achieve a better understanding of the nature of the present invention a preferred embodiment of a foiling missile and a foiling missile assembly will now be described, by way of example only, with reference to the accompanying drawings in which:

FIG. 1 is a perspective view of a foiling unmanned surface vessel (USV) according to an embodiment of a first aspect of the present invention;

FIGS. 2 and 3 are plan views from above and below, respectively, of the foiling (USV) of the embodiment of FIG. 1;

FIGS. 4 and 5 are side elevation and front views, respectively, of the foiling (USV) of the embodiment of the preceding figures;

FIG. 6 is a perspective view of a foiling (USV) assembly of an embodiment of a second aspect of the invention including the foiling (USV) of the first aspect of the preceding figures together with a launch sub-assembly;

FIGS. 7 and 8 are plan views from above and below, respectively, of the foiling (USV) assembly of the embodiment of FIG. 6 shown in part cutaway;

FIGS. 9 and 10 are side elevation and end views, respectively, of the foiling (USV) assembly of the embodiment of FIGS. 6 to 8 shown in part cutaway.

### DETAILED DESCRIPTION

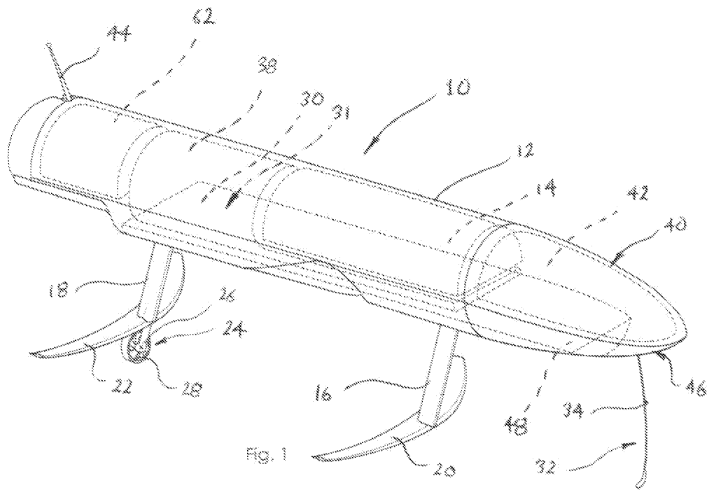

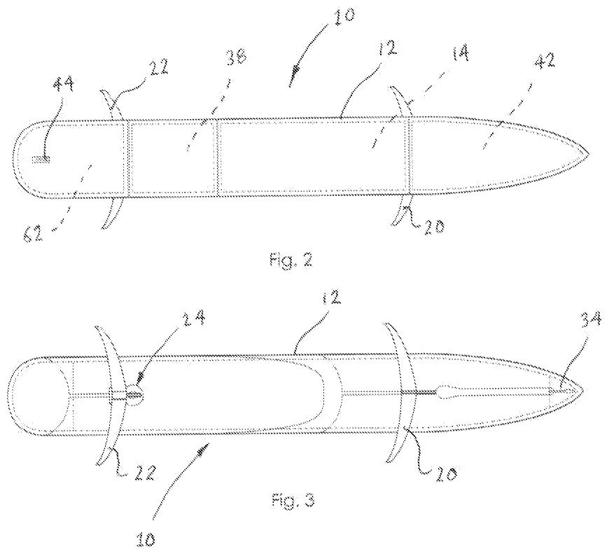

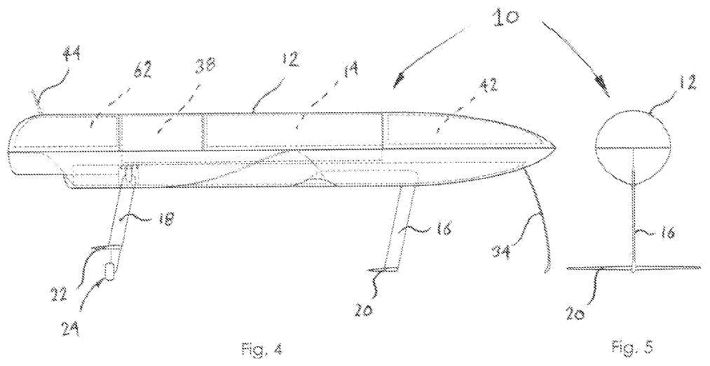

As seen in FIGS. 1 to 5, there is an unmanned surface vessel (USV) 10 of an embodiment of a first aspect of the invention. The foiling USV 10 of this embodiment broadly comprises:

1. a vessel body 12 adapted to contain a payload 14;
2. a front fin 16 and a rear fin 18 connected to and protruding from the vessel body 12;
3. a forward foil 20 and a rearward foil 22 connected to a distal end region of the respective front and rear fins 16 and 18;
4. propulsion means 24 operatively coupled to the rear fin 18 for propulsion of the fin 18 and the foil 22 through the water.

In this embodiment the foils 20 and 22 are, under the influence of the propulsion means 24, effective in lifting the vessel body 12 via the fins 16 and 18 substantially clear of the water. This means the foiling vessel 10 foils at relatively high speeds with the propulsion means 24 remaining submerged in the water. The USV 10 with this foiling capability has significantly reduced drag or water resistance by a factor of around 10 to 20 times compared with a conventional displacement or planing USV. This means the foiling USV 10 of this embodiment has an increased speed and range of a similar factor and as such can be deployed in operations not otherwise possible with the conventional USV, such operations including:

1. Sprint and drift operations ahead of a fleet;
2. Payload delivery one-way to a destination such as a weapon delivered to a target;
3. Moving swarms of USVs used to detect enemy ship(s).

In this embodiment the rearward fin 18 is pivotally mounted to the vessel body 12 for pivoting to effect steerage of the foiling USV 10. The forward fin 16 and the associated foil 20 are located at or near the centre of gravity of the foiling USV 10.

In this embodiment the propulsion means 24 includes an electric motor 26 mounted to or extending from a base of the rearward fin 18, and a propeller 28 coupled to the electric motor 26 for propulsion of the foiling USV 10. The electric motor 26 is in the form of an electric pod motor electrically coupled to and powered by a battery 30. The battery 30 is housed within a battery compartment 31 the vessel body 12. Although not illustrated, an upper surface of the vessel body 12 may be covered in solar panels to allow for charging of the battery 30 while the USV 10 is loitering just below the water's surface in a stealth mode.

In this embodiment the foiling USV 10 also comprises flight control means 32 operatively coupled to the vessel body 12 to control its flight above the water. The flight control means 32 includes a surface water actuator in the form of a wand 34 operatively coupled to the forward fin 16 for tilting of said fin 16 thereby changing the angle of the associated forward foil 20 relative to the water which influences the flight path of the vessel body 12. The wand 34 at or adjacent a proximal end is pivotally mounted to the front of the vessel body 12, a distal end 36 of the wand 34 being configured to skim the surface of the water during foiling of the foiling USV 10.

The surface water actuator 32 also includes a control line (not shown) connected between a proximal end of the wand 34 and a proximal end of the forward fin 16 for tilting of said fin 16 on pivotal movement of the wand 34. The wand 34 is thus designed, depending on the height of the vessel body 12 above the water, to control tilting of the forward fin 16 and the associated foil 20 thereby adjusting the flight path of the vessel body 12 to maintain foiling of the foiling USV 10.

In this embodiment the vessel body 12 includes a ballast compartment 38 in the form of a tank configured for flooding with water to effect sinking of the foiling USV 10. The ballast tank 38 is typically arranged for flooding when the vessel body 12 is substantially stationary and at least partly submerged in the water

The foiling USV 10 of this embodiment comprises a target sensor schematically designated at 40 associated with the front of the vessel body 12 for homing of the foiling USV 10 to a target or other location (not shown). The target sensor 40 is housed within a sensor compartment 42 and includes but is not limited to radar, visual sensors, infrared, or lidar. The target sensor 40 is in this example configured to communicate with target software such as recognition and collision avoidance software (not shown).

The foiling USV 10 of this embodiment further comprises navigation electronics (not shown) associated with the vessel body 12 to control tracking of the foiling USV 10 to the target. The navigation electronics includes a global positioning system (GPS) antenna 44 connected to a rear of the vessel body 12. The GPS antenna 44 of this example is retractably mounted to the vessel body 12.

The payload 14 may include one or more warheads wherein the foiling USV 10 takes the form of a weapon or missile. In this example, sinking of the foiling missile 10 is required when the warhead or other payload 14 is to be detonated or activated on the seabed or ocean floor. The foiling missile 10 also includes a detonator or activator schematically designated at 46 being operatively coupled to the payload 14 to activate said payload 14 on arrival at or impact with the target. The detonator or activator 46 is housed within a detonator or activator compartment 48 at the front of the vessel body 12. The foiling USV 10 may strike the target above or below water. In its sub-surface mode of operation, the foiling missile 10 may be configured to home an underwater torpedo where at the target the ballast tank is flooded for sinking of the missile 10 and subsequent detonation akin to a depth charger.

In another embodiment of this aspect of the invention, the foiling unmanned surface vessel (not shown) is designed for sprint and drift tactics or other defence operations. In this variation on the described embodiment, the foiling USV is of essentially the same construction as the USV 10 of the preferred embodiment except the warheads and associated payload are replaced with payload sensors. The payload sensors of this variation include but are not limited to camera, hydrophone, sonar, devices for sensing electronic signatures, and electronic warfare (EW) electronics including radio, infrared detectors, radar or lidar.

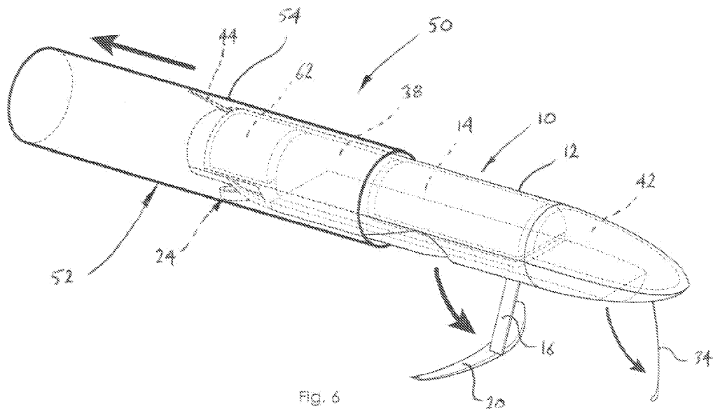

FIGS. 6 to 10 illustrate an embodiment of a second aspect of the invention directed to a foiling unmanned surface vessel (USV) assembly 50. The foiling USV assembly 50 of this embodiment generally comprises the foiling USV 10 of the embodiment of the preceding aspect of the invention together with a launch sub-assembly 52.

The launch sub-assembly 52 is arranged to cooperate with the foiling USV 10 for launching of the foiling USV 10 into the water. As described in the preceding aspect of the invention, the foils 20 and 22 are effective in lifting the vessel body 12 via the fins 16 and 18 substantially clear of the water for foiling of the foiling USV 10. Following launch of the foiling USV 10, it is expected that the propulsion means 24 will propel the foiling USV 10 through the water with increasing speed and decreased displacement and drag until foiling of the foiling USV 10 is possible at relatively high speed. It will be understood that the propulsion means 24 remains submerged in the water during the relatively high speed foiling of the foiling USV 10.

The launch sub-assembly 52 of this embodiment includes a launch tube 54 configured to contain the vessel body 12 in preparation for its launch from the launch sub-assembly 52. In this example the launch tube 54 is in cross-section shaped substantially circular and complementary to the external profile of the vessel body 12. The launch tube 54 is otherwise internally shaped cylindrical and substantially complementary to the majority of the vessel body 12 with the exception of its forward sections which taper inwardly.

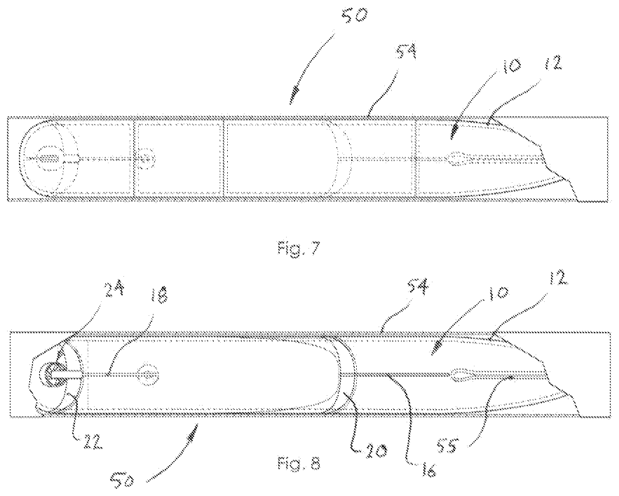

In this embodiment the foiling USV 10 operates in either a launch mode as seen in FIGS. 7 to 10 or a deployed mode as seen in FIGS. 1 to 5. In the launch mode, the vessel body 12 is contained in the launch tube 54 with the fins 16 and 18 and the associated foils 20 and 22 retracted. On the other hand, in the deployed mode of the foiling USV 10, the vessel body 12 is launched from the launch tube 54 with the fins 16 and 18 protruding from the vessel body 12 and the associated foils 20 and 22 in their operative position to promote foiling of the foiling USV 10.

In this embodiment the fins 16 and 18 are each pivotally mounted to the vessel body 12 for pivotal movement between its retracted and protruding positions. The foiling USV 10 also comprises biasing (not shown) coupled to each of the fins 16 and 18 to urge them toward the protruding position whereupon the associated foils 20 and 22 promote foiling of the foiling USV 10. FIG. 6 illustrates the forward fin 16 protruding and the associated foil 20 urged via the biasing means into the operative position with the rearward fin 18 in its retracted position being contained by the launch tube 54.

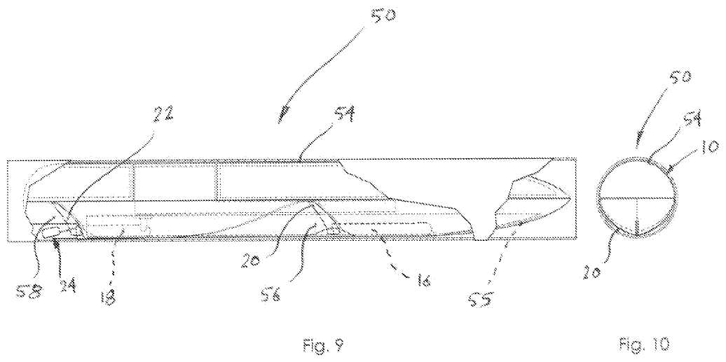

As best seen in FIGS. 6 and 9, the vessel body 12 includes a forward and rearward recess 58 and 60 within which respective of the fins 16 and 18 and their associated foils 20 and 22 nest with the vessel body 12 contained in the launch tube 54 in the launch mode. In this case the foils 20 and 22 are each constructed of a resiliently flexible material which deforms to permit nesting of each of the foils 20 and 22 within their respective recesses 58 and 60. It will be understood that, on launch of the foiling USV 10 from the launch tube 54 and pivoting of the fins 16 and 18 into their protruding positions, the associated foils 20 and 22 automatically move into their operative positions to promote foiling of the foiling USV 10. As best seen in FIG. 5, the foils 20 and 22 in the operative position extend in generally the same plane either side of the associated fins 16 and 18 substantially orthogonal to said fins 16 and 18, respectively. The vessel body 12 may also include a wand recess 55 within which the wand 34 nests with the foiling USV 10 in the launch mode.

The foiling USV 10 of this embodiment also comprises an aft compartment 62 from which the GPS antenna 44 extends. The aft compartment 62 is configured to contain electronics including but not limited to computers, inertial sensors, electronic compass, gyroscopes, navigation instruments, satellite communications, guidance and control electronics. The guidance and control electronics may include computers communicating remotely with one or more base stations via suitable communication networks for tracking and navigation of the foiling USV 10. It will be understood that this guidance and control electronics may communicate and cooperate with the target sensors at the front of the vessel body 12 to assist with homing of the USV 10 to the designated location or target. The foiling USV 10 may include autonomous systems providing the necessary redundancy in the event the foiling USV 10 loses the necessary communications or system required to effect tracking to the target or other location.

In operation the foiling USV 10 may be launched from the launch sub-assembly 52 above the water surface, at the water surface, or below the water surface. The launch sub-assembly 52 may for this purpose be located on a boat, ship, submarine or shore-based. Alternatively the launch sub-assembly 52 may be mounted in an aeroplane and launched via a parachute.

The foiling USV assembly 50 in an alternative arrangement may include a sleeve or canister (not shown) into which the foiling USV such as 10 is preloaded. The sleeve or canister is in turn loaded within the launch tube 54 in preparation for its launch. It is expected that the sleeve on impact with the water will be designed to open or release the foiling USV 10 for propulsion via the propulsion means 24 in the deployed mode of operation where it ultimately foils at relatively high speeds.

Now that a preferred embodiment of the foiling unmanned surface vessel has been described it will be apparent to those skilled in the art that it has at least the following advantages:

1. The foiling USV can foil at relatively high speeds in a stealth mode;
2. the foiling USV can foil at high speeds for relatively longer range than a comparable torpedo with similar propulsion “fuel” or power;
3. the foiling USV being propelled via propulsion means underwater is relatively quiet and consumes reduced power;
4. the foiling USV can operate solely in a one-way mode without requiring power or fuel for return;
5. the foiling USV need not be wire-guided like underwater torpedos as it is just above the surface and has communications via satellite or radio and has the capability to rely on navigation systems and/or sensors for effectively directing to a waypoint or other target;
6. the foiling USV can be designed to be launched from a launch sub-assembly in a similar manner to existing underwater torpedo launch arrangements.

Those skilled in the art will appreciate that the invention as described herein is susceptible to variations and modifications other than those specifically described. For example, the foil associated with each of the fins may be pivotally connected to the fins rather than relying upon the resilient flexibility of the foils of the preferred embodiment. In this variation the foils in the launch mode pivot about the corresponding fin to nest within the recess of the vessel body. The foiling USV may include a single foil most likely associated with the forward fin in which case the rear fin may be in the form of a rudder without a foil. The forward fin may pivot forward when stowed so that when deployed it is forced back into its protruding position.

All such variations and modifications are to be considered within the scope of the present invention the nature of which is to be determined from the foregoing description.

1. A foiling unmanned surface vessel comprising:
a vessel body containing a payload including payload sensors wherein the foiling unmanned surface vessel is intended for sprint and drift tactics or other defence operations;
a fin at a proximal end connected to and protruding from the vessel body;
a foil connected to a distal end region of the fin, the foil being oriented generally transverse to and extending from the fin;
propulsion means operatively coupled to the fin for propulsion of the fin and the foil through the water whereby the foil is effective in lifting the vessel body via the fin substantially clear of the water for foiling of the foiling unmanned surface vessel at relatively high speeds with the propulsion means remaining submerged in the water.

2. A foiling unmanned surface vessel as claimed in claim 1 wherein the payload sensors include but are not limited to camera, hydrophone, sonar, devices for sensing electronic signatures, and electronic warfare electronics including radio, infrared detectors, radar, or lidar.

3. A foiling unmanned surface vessel as claimed in claim 1 wherein the fin is one of a pair of fins located at a front and a rear of the vessel body, respectively, and wherein the foil is one of a pair of foils in the form of a forward and a rearward foil connected to the forward and the rearward fins, respectively.

4. (canceled)

5. A foiling unmanned surface vessel as claimed in claim 3 wherein the rearward fin is pivotally mounted to the vessel body for pivoting to effect steerage of the foiling unmanned surface vessel.

6. A foiling unmanned surface vessel as claimed in claim 3 wherein the forward fin and the associated foil are located at or near the centre of the gravity of the foiling unmanned surface vessel.

7. A foiling unmanned surface vessel as claimed in claim 1 wherein the propulsion means includes an electric motor mounted to the fin, and a propeller coupled to the electric motor for propulsion of the foiling unmanned surface vessel, the propulsion means including a battery housed within the vessel body and electrically coupled to the electric motor for powering it.

8. (canceled)

9. A foiling unmanned surface vessel as claimed in claim 7 wherein the electric motor is in the form of an electric pod motor.

10. A foiling unmanned surface vessel as claimed in claim 1 also comprising flight control means operatively coupled to the vessel body to control its flight above the water, the flight control means including a surface water actuator operatively coupled to the fin for tilting of the fin thereby changing the angle of the foil relative to the water which influences the flight path of the vessel body.

11. (canceled)

12. A foiling unmanned surface vessel as claimed in claim 10 wherein the surface water actuator includes a wand at a proximal end being pivotally mounted to the front of the vessel body, a distal end of the wand configured to skim the surface of the water and, depending on the height of the vessel body above the water, pivot for tilting of the fin thereby adjusting the flight path of the vessel body to maintain foiling of the foiling unmanned surface vessel.

13. (canceled)

14. A foiling unmanned surface vessel as claimed in claim 10 wherein the foil or part thereof is moveable via the surface water actuator to influence the flight path of the vessel body.

15. (canceled)

16. A foiling unmanned surface vessel as claimed in claim 1 wherein the vessel body includes a ballast tank configured for flooding with water to effect sinking of the foiling unmanned surface vessel, the ballast tank being arranged for flooding when the vessel body is substantially stationary and at least partly submerged in the water.

17. (canceled)

18. A foiling unmanned surface vessel assembly comprising:
a) a foiling unmanned surface vessel including:
a vessel body containing a payload including payload sensors wherein the foiling unmanned surface vessel is intended for sprint and drift tactics or other defence operations;
a fin at a proximal end connected to and protruding from the vessel body;
a foil connected to a distal end region of the fin, the foil being oriented generally transverse to and extending from the fin;
propulsion means operatively coupled to the fin for propulsion of the foil through the water,
b) a launch sub-assembly arranged to cooperate with the foiling unmanned surface vessel for launching of said unmanned vessel into the water whereby the foil is effective in lifting the vessel body via the fin substantially clear of the water for foiling of the foiling unmanned surface vessel at relatively high speed with the propulsion means remaining submerged in the water.

19. A foiling unmanned surface vessel assembly as claimed in claim 18 wherein the launch sub-assembly includes a launch tube configured to at least in part contain the vessel body in preparation for its launch from the launch sub-assembly.

20. A foiling unmanned surface vessel assembly as claimed in claim 19 wherein the launch tube is internally shaped at least in part substantially complementary to the vessel body.

21. A foiling unmanned surface vessel assembly as claimed in claim 18 wherein the foiling unmanned surface vessel is configured to operate in either i) a launch mode where the vessel body is contained in the launch tube with the fin and the associated foil retracted, or ii) a deployed mode where the vessel body is launched from the launch tube with the fin protruding from the vessel body and the associated foil in its operative position to promote foiling of the foiling unmanned surface vessel.

22. A foiling unmanned surface vessel assembly as claimed in claim 21 wherein the vessel body includes a fin and foil recess within which the fin and the foil nest with the vessel body contained in the launch tube in the launch mode.

23. A foiling unmanned surface vessel assembly as claimed in claim 21 wherein the foil is at least in part constructed of a resiliently flexible material which with the foiling unmanned surface vessel in the launch mode deforms to permit nesting of the foil within the fin and foil recess.

24. A foiling unmanned surface vessel assembly as claimed in claim 21 wherein the foil is pivotally connected to the fin whereby in the launch mode pivoting of the foil about the fin permits nesting of the foil within the fin and foil recess.

25. A foiling unmanned surface vessel assembly as claimed in claim 21 wherein the fin is pivotally mounted to the vessel body for pivotal movement between its retracted and protruding positions.

26. A foiling unmanned surface vessel assembly as claimed in claim 25 also comprising biasing means coupled to the fin to urge it toward the protruding position whereupon the associated foil promotes foiling of the foiling unmanned surface vessel.

27-36. (canceled)
